(19) United States
(12) Patent Application Publication
(10) Pub. No.: US 2018/0218165 A1
(43) Pub. Date: Aug. 2, 2018

(54) Method for Locking Sensitive Data in the Cloud Based on Refactoring Technology

(71) Applicant: Peking University, Beijing (CN)

(72) Inventors: Hong Mei, Beijing (CN); Gang Huang, Beijing (CN); Ying Zhang, Beijing (CN); Huaqian Cai, Beijing (CN)

(21) Appl. No.: 15/519,876

(22) PCT Filed: Feb. 17, 2016
(86) PCT No.: PCT/CN2016/073912

§ 371 Date: Apr. 18, 2017

(30) Foreign Application Priority Data
Oct. 13, 2015 (CN) 201510670320.2

(51) Int. Cl. G06F 21/62; G06F 17/30; G06F 8/72

(52) U.S. Cl. CPC G06F 21/6218; G06F 17/30171; G06F 2221/2147; G06F 17/30115; G06F 8/72; G06F 17/30005

(57) ABSTRACT

A method for cloud locking sensitive data based on refactoring technology is disclosed. Binary byte codes of a mobile application are modified and refactored, and an application program interface related to the file operation used by the mobile application is replaced, so that a sub-file system specified in the cloud is fused with the file system in the client. The refactored application is capable of transparently reading and writing cloud data and cloud locking sensitive data. The method includes: carrying out programmed analysis on the existing mobile application; finding a computational logic related to the file operation and carrying out corresponding refactoring; and re-generating an application with direct cloud data reading/writing capability. The invention method is conducive to improving the security of sensitive data on mobile phones, and has particular significance for users that want to protect sensitive data without storing them on their clients.

### TECHNICAL FIELD

The present invention relates to the technical field of computer software technology, and in particular, is applicable to software maintenance. The invention method accomplishes file locking in the plurality of devices in the existing application by using program analysis and refactoring technology, so as to realizing locking sensitive data in the cloud.

### BACKGROUND OF THE INVENTION

With the development of smart phones, users are increasingly using mobile devices to conduct office work and business to improve life and work efficiency. At the same time, more and more user sensitive data is saved on mobile phones. However, these sensitive data still face a variety of threats, such as loss of mobile phones, data loss caused by damage, malicious applications, leakage of sensitive data caused by mobile phone viruses, and other issues. To address data loss and data leakage, data isolation protection technology based on cloud storage exemplified by network disk has been developed. However, for the current network disk, when users need to read and write these data, the data must first be downloaded from the cloud-side to the client-side. In other words, the user's data is stored in the client-side (i.e. mobile phone), and also stored in the cloud. The data synchronization between the cloud and the client is performed by the user. This technology can only solve the problem of mobile phone loss and data loss caused by phone damage, but has not solved the problem of data leakage from the client on which the data is stored. Because the data is still stored on the phone, even if the existing data isolation is protected, no matter how good data encryption and isolation mechanism is, malicious applications can launch various attacks which cannot be completely avoided.

In view of the above, there is a need for a method to support data cloud-client convergence. It should be implemented without a second development by the application developers, allowing existing applications to read and write cloud data transparently. Users protect sensitive data by storing them in the cloud, thereby solving problems of mobile phone loss and loss of sensitive data caused by phone damage; users directly read and write cloud data, so that data is not stored in the client, which solves the problem of leakage of user sensitive data.

### SUMMARY OF THE INVENTION

The object of the present invention is to protect user sensitive data. The core idea is to designate, by the user, part of the application on the client side as trusted application, and to store sensitive data in the cloud. By conducting program analysis of and refactoring the trusted applications, these applications are enabled with the capability to access cloud-sensitive files. The invention method saves user sensitive data in the cloud to ensure that the sensitive data is not leaked. The method only refactors user's trusted applications, which guarantees sensitive data not to be leaked.

The technical implementation of adopted by the present invention is as follows:

A method for cloud locking sensitive data based on refactoring technology, including the steps of:

1) designating, by the user, part of an original application on the client side as a trusted application, and storing sensitive data in a cloud;

2) refactoring the designated trusted application; replacing the File Access API, which can call files, in the original application by a Cloud-Client Convergence File Access (CCCFA) API, which can access remote files in the cloud as well as local file in the client; and

3) allowing the application to access the sensitive data in the cloud by calling the CCCFA API.

Further, step 2) in the above describe method can includes

a) using keyword matching to find all file-related classes;

b) refactoring a first part of File Access API that can instantiate original file-related objects to the corresponding portion in the CCCFA API, which will instantiate wrapped file-related objects capable of manipulating cloud data; the refactoring process ensuring the consistency between the original file-related objects and the wrapped file-related objects in the inheritance chain, as well as consistency in operations and attributes; and

c) refactoring a second part of File Access API that uses the original file-related objects (callee); dividing a caller of the File Access API into two categories: the application layer objects and framework layer objects.

Further, the above step a) further includes first constructing a keyword database for the File Access API using framework layer library, and then finding all the classes in the application that use the File Access API based on the keyword database.

Further, in step c) above, when the caller is framework layer object, refactoring the callee to the original file-related object by invoking wrapped file-related object, and the framework layer object can directly manipulate the original file-related object.

Further, the refactoring process of step 2) causes the original file-related objects at runtime to be replaced with wrapped file-related objects that have cloud data manipulation capabilities; the wrapped file-related objects capable of cooperating with the cloud-based data agent running in the cloud, using the file system fusion mechanism to achieve integration of cloud-client data.

Further, the file system fusion mechanism can include file system fusion based on file mapping: first specifying a sub-file system in the cloud, which includes a set of files and directories; and then specifying rules for mapping cloud files to client files, and finally completing mapping cloud files to client files by the cloud data agents running on the client and in the cloud, thereby achieving integration of file systems on the client and in the cloud.

Further, the file system fusion mechanism can further include file metadata caching and synchronization based on timestamps, i.e., incremental synchronizing metadata of cloud file based on timestamps, which can improve overall system performance and availability.

The present invention proposes a method of supporting locking sensitive data in the cloud, which enables trusted mobile applications to directly access sensitive data stored in the cloud, without storing sensitive data on the client. The method does not require a second development by the application developers, the existing mobile applications can be automatically refactored with programs, allowing existing applications to read and write cloud data transparently. On one hand, the invention method incorporates advantages of the conventional technologies, and solves the problem of data loss caused by phone loss and phone damages by storing the sensitive data needed to be protected in the cloud. On the other hand, the method innovatively directly reads and writes sensitive data as cloud data; the sensitive data is not stored on the client side, which overcomes the problem of leakage of user sensitive data.

### BRIEF DESCRIPTION OF THE DRAWINGS

FIG. 1 is a schematic diagram of the runtime architecture showing changes before and after refactoring.

FIGS. 2A and 2B are schematic representations of the file systems, wherein FIG. 2A shows two file systems before fusion, and FIG. 2B is the result after fusion.

FIGS. 3A and 3B are schematic diagrams of the code before and after the reconstruction, wherein FIG. 3A is the code prior to refactoring, and FIG. 3B is the code after refactoring.

### DETAILED DESCRIPTION OF IMPLEMENTATIONS

The foregoing objects, features and advantages of the present invention will become more apparent from the following detailed description of the present invention when taken in conjunction with detailed implementation examples and the accompanying drawings.

The present invention provides a method for cloud locking sensitive data using program analysis and refactoring techniques. The method includes two parts: 1. a method to achieve sensitive data cloud locking using application refactoring; 2. file system fusion mechanism. The core idea is to modify and refactor binary byte code of the mobile application, replacing the application programming interface (API) associated with the file operation it uses, so that integrating a subfile system designated in the cloud and the file system of the client side. The refactored application can transparently read and write cloud data, thereby achieving the cloud locking of sensitive data. This method firstly programmatically analyzes the existing mobile application, identifies calculation logic related to the file operations, conducts corresponding refactors, and finally re-generates an application capable of directly reading and writing cloud data. The present invention is very beneficial to improving the security of mobile sensitive data, especially significant for users who want to protect sensitive data without storing the sensitive data on their mobile devices.

The specific technical solutions of the invention are as follows:

(1) a method to achieve sensitive data cloud locking using application refactoring

Existing mobile applications usually conduct file related operations using the File Access API provided by the framework layer. The present method uses program analysis and refactoring to replace the original File Access API for calling files in the original application by a Cloud-Client Convergence File Access (CCCFA) API associated with files after fusion of the cloud and the client side. The application can access sensitive data in the cloud by calling the CCCFA API, and read and write the sensitive data in the cloud.

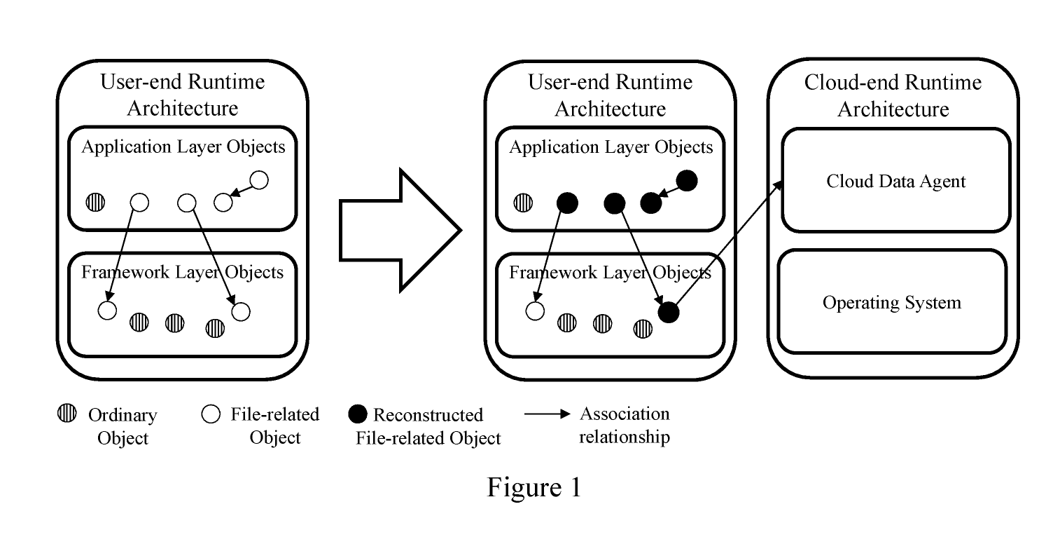

Changes in the application runtime architecture before and after the refactoring are shown in FIG. 1. To replace file related objects at run-time of the application with file related objects capable of operating in the cloud, the specific refactoring process includes the following steps:

(a) using keyword matching to find all file-related classes

The application uses the File Access API provided by the existing framework layer to manipulate the user data. In order for the application to have the ability to manipulate cloud data, the present method first builds a keyword database for file-related operations in the existing framework layer, and then uses the keyword database to find all the classes in the application that use the File Access API. Finally, these classes undergo the following two types of refactoring.

(b) refactoring the API associated with instantiating file-related objects

As shown in FIG. 1, to ensure that all file-related objects to be replaced with objects capable of operating cloud data, the present method refactors all the File Access API that can instantiate file-related objects to the corresponding CCCFA API that instantiates wrapped file-related objects capable of manipulating cloud data, while ensuring consistency of the wrapped file-related objects and the original file-related objects in the inheritance chain, and consistency in operations (Method) and attributes (Field). For example, in the implementation example, we implement FlowFile classes that have the ability to manipulate cloud data for a commonly used file-related class File class in the Android application. All operation (Method) and attributes (Field) of the FlowFile classes are consistent with the File class. But for some special operations, the FlowFile classes show properties of the cloud-client fusion, for example, the listFile operation returns the files from the sub-file system in the cloud and the file system on the client.

(c) refactoring the part of File Access API that calls the file-related objects

There are two kinds of objects that call file-related objects: one being application layer objects, and the other being the framework layer objects. For all application layer objects, the correctness of the program can be ensured by consistencies among the object inheritance chain, object operations and object attributes. The framework layer objects, on the other hand, also involve some attributes and operations in the system layer in addition to operations of calling the file-related objects. To ensure the correctness of the program, for some special framework layer objects, when calling file-related objects, the present method uses a special method of wrapped file-related objects to acquire the original file-related objects, to allow framework layer objects to directly manipulate the original file-related objects.

(2) file system fusion mechanism

The above-mentioned refactoring process causes file-related objects at runtime to be replaced with wrapped objects with cloud data manipulation capability. These objects work with the cloud data agent running in the cloud, and use file system fusion mechanism to achieve integration of cloud-client data. The file system fusion mechanism mainly includes the following two aspects:

(a) File system fusion based on file mapping

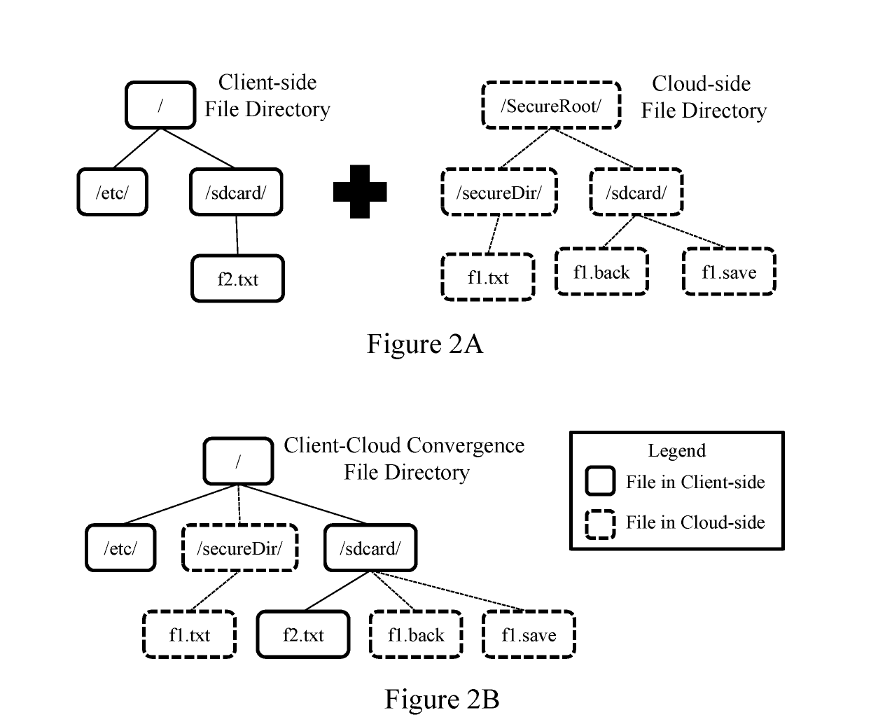

In order for the application to transparently operate cloud sensitive data, the present disclosure proposes an application level fusion mechanism for the file systems. First, the user specifies a sub-file system in the cloud, which is a collection of files and directories. Then the user specifies the rules for mapping cloud files to the terminal files. Finally, running the cloud data agents on the client and in the cloud to map cloud files to client files, to achieve the fusion of the two file systems. FIG. 2A shows the two file systems, and FIG. 2B shows the result system after the fusion.

(b) Timestamp-based file metadata caching and synchronization

The operations of an application to the file system can be divided into metadata operations and data operations. Metadata operations include reading file size, file name, copying files, moving files, deleting files, and so on. These operations are not related to the data of the file and do not need to transfer the data from the cloud to the client. Data operations include reading and writing file content. The present method enhances the overall system performance and availability by incrementally synchronizing the cloud metadata based on timestamps.

Implementation example:

This section gives the implementation of cloud-client data fusion in Android applications. Here is a section of code, for example, describes the refactoring process examples and refactored run-time architecture examples.

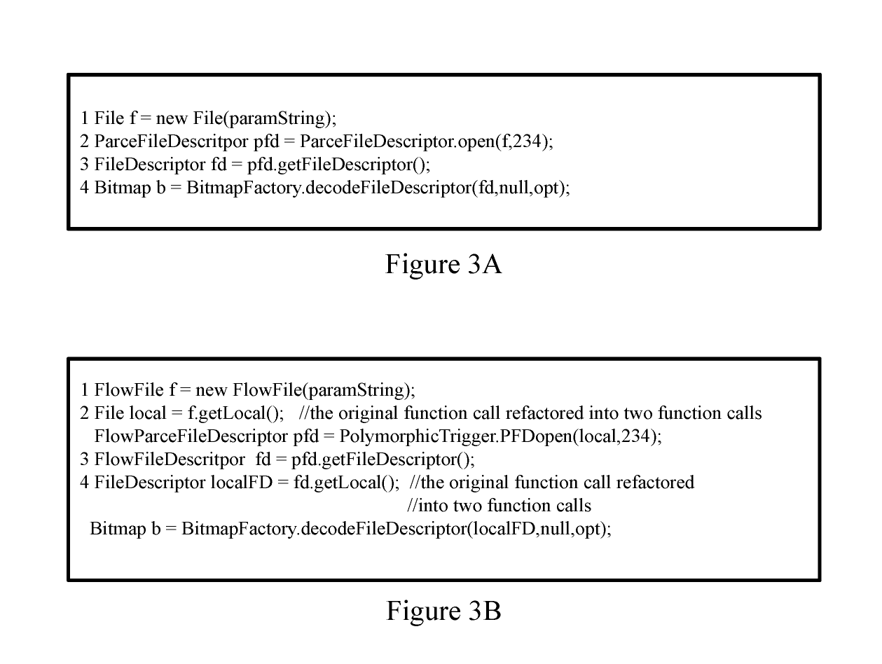

FIG. 3A shows the above described code before the refactoring of the code. Three file related objects are generated: first, new File (paramString) produced a File object; Second, the File object was passed to Open( )as a parameter, then a ParcelFileDescriptor object was produced; the third is the use of ParcelFileDescriptor object getFileDescriptor( ) operation produced a FileDescriptor object. Among the three objects, the first is created by the new keyword, the second by the factory ParcelFileDescriptor.open function; the third is generated by common operation getFileDescriptor of the framework layer object ParcelFileDescriptor.

The code after refactoring is shown in FIG. 3B, including the refactoring of three file objects:

1. The object created by new File will be replaced by the new FlowFile object. At this point, the FlowFile is equipped with capability of operating cloud data objects.

2. Since the factory function Open will produce a file-related object ParcelFileDescriptor, the factory function open is refactored to PFDopen, the resulting object is FlowParcelFileDescriptor.

3. FlowFileDescriptor is generated by the getFileDescriptor of FlowParcelFileDescriptor. Moreover, two call-related objects are refactored: 1) since the FlowFile object is passed to the open function of the framework layer as an argument, the function getLocal( )is needed to acquire the original object File object of the FlowFile. 2) since the FlowFileDescriptor object is passed as a parameter to the function decodeFileDescriptor in the framework layer, fd is thus refactored into fd.getLocal to obtain the original FileDescriptor.

After the above refactoring, the runtime architecture of the refactored application becomes what is shown on the right side of FIG. 1, wherein the refactored application has the capability to incorporate data from the fused cloud-client side.

The above example is implemented using Davlik bytecode. The method can also be similarly refactored using different byte codes, intermediate codes, such as Java bytecode, and other intermediate representations under the Soot framework.

The foregoing embodiments are merely intended to illustrate the technical solutions of the present invention, and are not intended to be limiting thereof. One of ordinary skill in the art may modify or equivalently replace the technical solution of the present invention without departing from the spirit and scope of the invention. The scope of protection shall be governed by the claims.

What is claimed is:

1. A method for locking sensitive data in the cloud based on refactoring technology, comprising the steps of:
1) designating part of an original application on a client side as a trusted application; storing sensitive data in a cloud;
2) refactoring the trusted application; replacing a part of File Access API that calls files in the original application by a Cloud-Client Convergence File Access (CCCFA) API associated with files after fusion of the cloud and the client; and
3) allowing the application to access the sensitive data in the cloud by calling the CCCFA API.

2. The method of claim 1, wherein the step 2) further comprises:
a) using keyword matching to find all file-related classes;
b) refactoring a first part of File Access API that instantiates original file-related objects to a corresponding portion in CCCFA API, which instantiates wrapped file-related objects capable of manipulating cloud data, thereby ensuring consistency between the wrapped file-related objects and the original file-related objects in the inheritance chain, as well as consistency in operations and attributes; and
c) refactoring a second part of File Access API that uses the original file-related objects (callee), dividing a caller of the File Access API into two categories: application layer objects and framework layer objects.

3. The method of claim 2, wherein step a) further comprises:
constructing a keyword database for the File Access API using framework layer library; and
finding all the classes in the application that use the File Access API based on the keyword database.

4. The method of claim 2, wherein step c) further comprises:
when the caller of the File Access API is a framework layer object, refactoring the callee to the original file-related objects which is acquired by invoking a method of the wrapped file-related objects, and wherein the framework layer object is capable of directly manipulating original file-related object.

5. The method of claim 1, wherein step 2) further comprises:
replacing the file-related objects at runtime with wrapped file-related objects, wherein the wrapped file-related objects capable of cooperating cloud data operations with the cloud data agent; and
achieving integration of cloud data and client data using file system fusion mechanism.

6. The method of claim 5, wherein the file system fusion mechanism includes file system fusion based on file mapping, the method further comprising:
specifying a sub-file system in the cloud, which includes a set of files and directories;
specifying rules for mapping cloud files to client files; and
completing mapping cloud files to client files by running the cloud data agents on the client and in the cloud, thereby achieving integration of file systems on the client and in the cloud.

7. The method of claim 6, wherein the file system fusion mechanism further includes file metadata caching and synchronization based on timestamps, which includes incremental metadata synchronization based on timestamps, thereby improving overall system performance and availability.
